(19) United States
(12) Patent Application Publication
(10) Pub. No.: US 2008/0104529 A1
(43) Pub. Date: May 1, 2008

(54) DRAGGABLE LEGENDS FOR SQL DRIVEN GRAPHS

(75) Inventors: Larry J. Cravens, Pine Island, MN (US); Ron T. McCargar, Rochester, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/554,809

(22) Filed: Oct. 31, 2006

(51) Int. Cl. G06F 17/30

(52) U.S. Cl. 715/764; 707/3; 715/215

(57) ABSTRACT

A computer program product for providing a graphical user interface for graphing results of a Structured Query Language (SQL) is presented and calls for displaying fields identified by the query; identifying selected fields from the query for graphing; and graphing the data from the selected fields.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to using a graphical user interface to drag and drop fields to establish graphing parameters in SQL driven graphs.

2. Description of the Related Art

Scientists and engineers have increasingly become dependent on using computer displayed graphs of data. Graphs provide a quick way to analyze large quantities of computer-stored data. The data in computers may be stored in a relational database. In the relational database, the data is stored as a collection of relations. Data of a similar type is stored in the same “field.” The relational database may have many fields. Scientists and engineers can use Structured Query Language (SQL) to analyze data in the relational database. For example, SQL can be used to display data from selected fields. The data selected for display by SQL is the result of a query. A “query” (SQL query) is a set of instructions submitted in SQL. Graphs displaying data as a result of SQL queries are referred to as “SQL driven graphs.”

Typically, a user will submit a query to select the data for display. To graph the data, the user will have to input graph display commands. The graph display commands will establish graphing parameters. For example, the user will have to enter commands to establish which field or fields will be displayed on the Y-axis. After viewing the graph, the user may decide to view another graph. To view another graph with different fields, new graph display commands will have to be entered. Each time the user decides to view another graph, new graph display commands have to be entered. Establishing graphing parameters each time the user decides to view other fields can be time consuming and frustrating.

Stylistic applications can be used to help interpret the data displayed. The stylistic applications affect how graphs “look.” The look includes graph details that would help one to understand the data presented in the graphs. The stylistic applications may include different colors, outlines, and textures. The user must enter commands every time he or she decides to change the look of the graph. As with changing the graphing parameters, changing the stylistic applications can be time consuming and frustrating.

What are needed are software and hardware to allow fields and stylistic applications to be dragged and dropped into and out of graphs using a graphical user interface.

### SUMMARY OF THE INVENTION

The shortcomings of the prior art are overcome and additional advantages are provided through the provision of a computer program product stored on machine readable media including machine readable instructions for providing a graphical user interface for graphing results of a Structured Query Language (SQL), the instructions implementing a method including displaying fields identified by the query; identifying selected fields from the query for graphing; and graphing the data from the selected fields.

Also disclosed is a computer system including a computer program product having instructions for providing a graphical user interface for graphing results of a Structured Query Language (SQL) query, the product including instructions for displaying fields identified by the query; displaying a listing of the fields identified by the query; identifying selected fields from the query for graphing; selecting fields from the displayed fields by using a pointing device; graphing the data from the selected fields; dragging and dropping the selected fields for the graphing; dragging and dropping the selected fields into a graphing parameter section; dragging and dropping the selected fields from the graphing parameter sections; providing an X-axis; providing a secondary X-axis; providing a primary Y-axis; providing a secondary Y-axis; providing a flyover window; providing graphical enhancements; graphing the data in the order the selected fields are presented in the graphing parameter sections; and changing an order of the selected fields.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which includes a computer program product stored on machine readable media including machine readable instructions for providing a graphical user interface for graphing results of a Structured Query Language (SQL), the instructions implementing a method including displaying fields identified by the query; identifying selected fields from the query for graphing; and graphing the data from the selected fields. The invention further includes displaying a listing of the fields identified by the query; selecting fields from the displayed fields by using a pointing device; dragging and dropping the selected fields for the graphing; dragging and dropping the selected fields into a graphing parameter section; dragging and dropping the selected fields from the graphing parameter sections; providing an X-axis; providing a secondary X-axis; providing a primary Y-axis; providing a secondary Y-axis; providing a flyover window; providing graphical enhancements; graphing the data in the order the selected fields are presented in the graphing parameter sections; and changing an order of the selected fields.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts aspects of a computing infrastructure for implementation of the teachings herein;

FIG. 2 illustrates aspects of a graphical user interface;

FIG. 3 illustrates one example of the graphical user interface; and

FIG. 4 is an exemplary flow diagram depicting aspects of a method 40 for providing the graphical user interface for SQL driven graphs.

The detailed description explains the preferred embodiments of the invention, together with advantages and features, by way of example with reference to the drawings.

### DETAILED DESCRIPTION OF THE INVENTION

The teachings herein provide for graphing of data resulting from queries conducted using a Structured Query Language (SQL). One skilled in the art will recognize that each such query will return data in a format that includes a list of fields. The techniques provided herein let a user select desired fields of data for generation of graphic images (i.e., a graph) thereof. The selection process makes use of graphic user interface (GUI) technologies.

The various commands provided by the user for generating each graphic image are referred to as “graph display commands.” For example, a graphic image may represent a field resulting from an SQL query. Using the GUI, graphing the field on the X-axis is accomplished by moving the graphic image with a mouse to a location representing the graph display command for the X-axis. The GUI action of moving the image to the new location is all that is required to graph the field on the X-axis.

One GUI technique is referred to as “drag and drop.” In one embodiment with drag and drop, the user points to a graphic image representation of data using the mouse pointer. The user depresses a mouse button. Keeping the mouse button depressed, the user moves the pointer (i.e., drags the graphic image) to another location on the display. The user releases the button to stop the movement (i.e., drop) of the graphic image. The command represented by the new location will be executed on the data. The mouse may represent any one of a number of input pointing devices.

The drag and drop technique may be applied to graph display commands. For example, the fields resulting from the SQL query are presented in a list. All the fields in the list are available for graphing. A graphic image may include a correlation to a respective field. For example, the graphic image may include the title of the field. Separate graphing parameter sections (locations) represent the graph display commands for different parts of the graph (i.e., for example, X-axis and Y-axis). Dragging and dropping one field from the list to one graphing parameter section will cause that field to be graphed. Similarly, dragging and dropping another field from the list to the same graphing parameter section will cause the new field to be graphed along with the prior field. If the graph is a bar chart, then values of one field may be stacked onto the values of the other field. Conversely, dragging and dropping the field from the graphing parameter section removes the field from the graph.

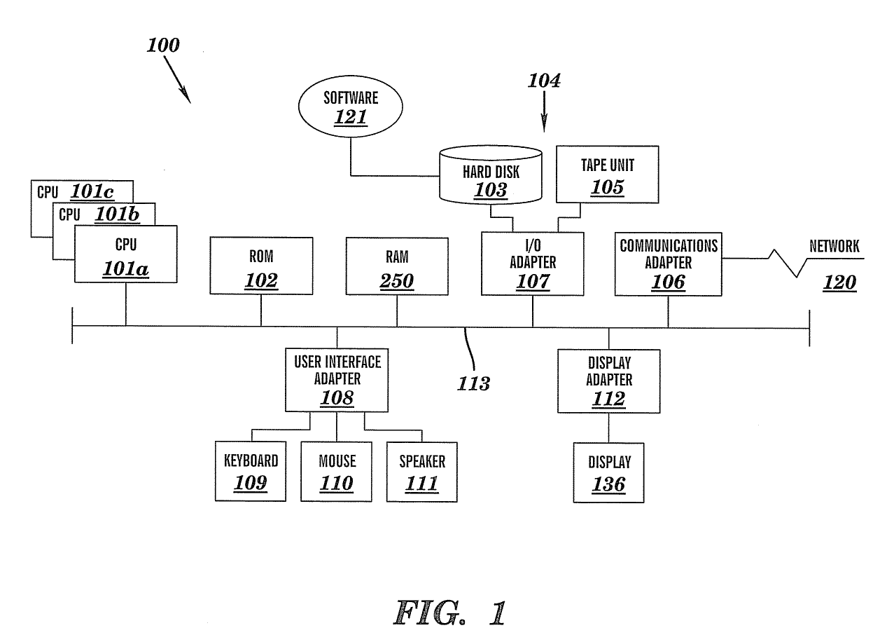

Referring now to FIG. 1, an embodiment of a processing system 100 for implementing the teachings herein is depicted. System 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 250 and various other components via a system bus 113. Read only memory (ROM) 102 is coupled to the system bus 113 and may include a basic input/output system (BIOS), which controls certain basic functions of system 100.

FIG. 1 further depicts an I/O adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. A network adapter 106 interconnects bus 113 with an outside network 120 enabling data processing system 100 to communicate with other such systems. Display monitor 136 is connected to system bus 113 by display adaptor 112, which may include a graphics adapter to improve the perfonnance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

As disclosed herein, the system 100 includes machine readable instructions stored on machine readable media (for example, the hard disk 103) for providing for the graphical user interface (GUI). As disclosed herein, the instructions are referred to as graphical user interface software 121. The software 121 may be produced using software development tools as are known in the art.

Thus, as configured FIG. 1, the system 100 includes processing means in the form of processors 101, storage means including system memory 250 and mass storage 104, input means such as keyboard 109 and mouse 110, and output means including speaker 111 and display 136. In one embodiment a portion of system memory 250 and mass storage 104 collectively store an operating system such as the AIX® operating system from IBM Corporation to coordinate the functions of the various components shown in FIG. 1.

As is known in the art, the system 100 may perform various functions. For example, the system 100 may provide server capabilities, or provide client resources. The system 100 may operate in a mixed platform environment. For example, the system 100, and other similar resources may operate any one of Windows, AIX and Solaris operating systems. The teachings herein provide for software 121 that is typically flexible. That is, the software 121 will typically operate in cross platform environments as well as with multiple systems. The software 121 provides the graphical user interface. The software 121 may be provided as an “add-in” to an application (where “add-in” is taken to mean supplemental program code as is known in the art). In such embodiments, the software 121 replaces structures of the application for providing the graph display commands described herein.

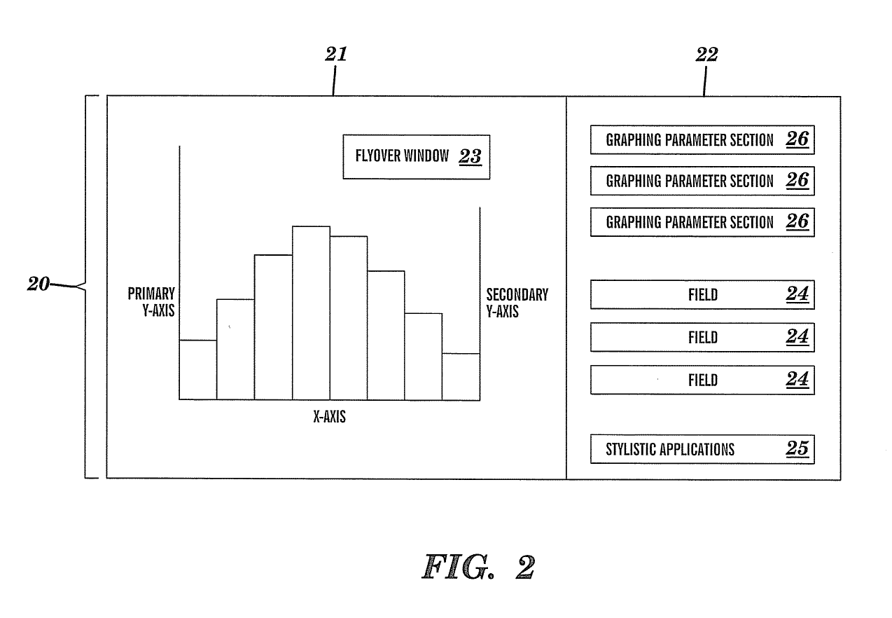

FIG. 2 presents aspects of the graphical user interface (GUI) 20. Typically, the GUI 20 is displayed by the display 136. The GUI 20 includes a graph 21 and a legend 22. Typically, the graph 21 will provide graph data resulting from an SQL query by use of the graph display commands. The SQL query will retrieve data from the relational database. The graph display commands will graph selected data resulting from the SQL query. Typically, the graph 21 includes an X-axis and a Y-axis. In one embodiment, the graph 21 may include a secondary Y-axis. The secondary Y-axis may display data with units different from the units of the primary Y-axis. Likewise, the X-axis may include a secondary X-axis (not shown).

In one embodiment, the graph 21 may include a flyover window 23. The flyover window 23 presents data associated with the graph 21. Specifically, the data in the flyover window 23 corresponds to a region on the graph 21 to which the mouse 110 points.

Typically, the legend 22 includes a listing of all fields 24 that result from the SQL query. The listing provides fields 24 available for graphing. The fields 24 are selected from the listing for graphing. When a field is selected, it is moved into a graphing parameter section 26. The fields 24 previously moved into the graphing parameter sections 26 may be moved from the sections as needed.

The legend 22 also includes the graphing parameter sections 26. In one embodiment, the graphing parameter sections 26 include sections for the X-axis, the primary Y-axis, the secondary Y-axis and the flyover window 23. Typically, the fields 24 may be graphed by dragging and dropping them from the listing to the graphing parameter sections 26. Conversely, the fields 24 may be removed from the graph 21 by dragging and dropping them from the graphing parameter sections 26. The fields 24 may also be graphed by dragging and dropping them to other areas of the GUI 20.

In one embodiment, the order of data presented in bar charts in the graph 21 corresponds to the order in which the fields 24 are listed in the graphing parameter section 26. For example, the data graphed first at the bottom of the bar chart would correspond to the first field 24 listed in the graphing parameter section 26. To change the order of the data graphed, all one has to do is drag and drop the fields 24 into the order one desires. Typically, the order of the selected fields 24 is changed by dragging and dropping.

The legend 22 also includes stylistic applications 25. The stylistic applications 25 are graphical enhancements that aid the user in interpreting the graph 21. For example, in one embodiment, the stylistic applications 25 include a pallet of colors. Typically, the user chooses colors with which to display data in a bar chart for the graph 21. In one embodiment, the user can drag and drop a selected color to the graph 21. In another embodiment, the stylistic applications 25 include a list of graphical enhancements that may be applied to the graph 21.

The stylistic applications 25 may include many options such as dotted lines dashed lines, textures, background colors, and outline colors. Typically, the stylistic applications 25 provide for labeling the X and Y-axes. In one embodiment, the X and Y-axes may be labeled by clicking the axes, where “clicking” is the GUI 20 process of entering a selection command.

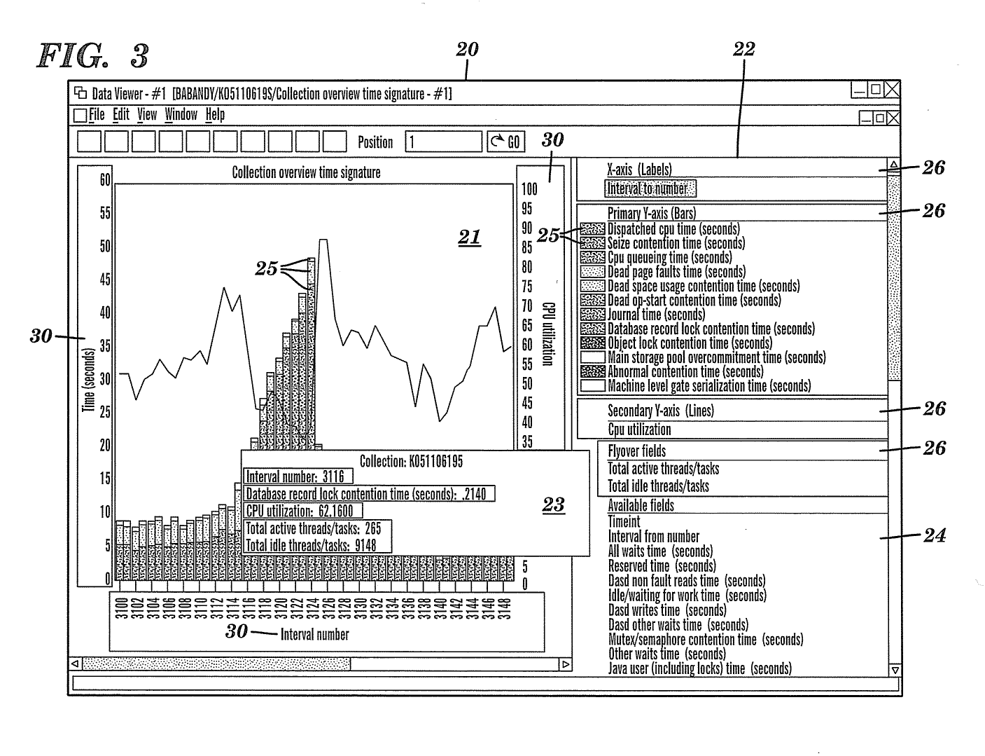

FIG. 3 presents one example of the GUI 20 for SQL driven graphs. Referring to FIG. 3, the GUI 20 includes the graph 21 and the legend 22. The graph 21 includes the X-axis, the primary Y-axis, the secondary Y-axis, and the flyover window 23. The legend 22 includes the fields 24, the graphing parameter sections 26, and the stylistic applications 25. In this example, the fields 24, located under the heading “Available Fields,” are graphed by dragging and dropping them into the graphing parameter sections 26. This example also includes axis labels 30.

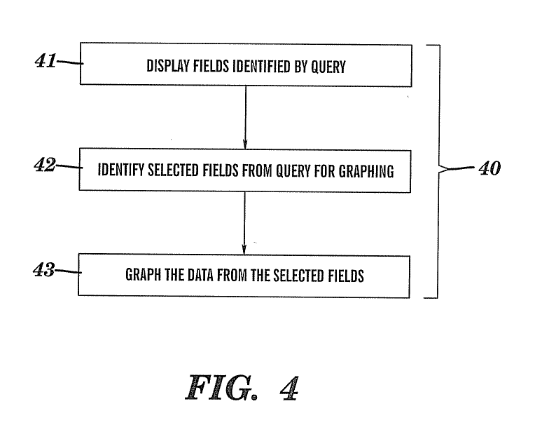

FIG. 4 is an exemplary flow diagram depicting aspects of a method 40 for providing the GUI for SQL driven graphs. A first step 41 calls for displaying the fields 24 identified by the query. All the displayed fields 24 are available for graphing. A second step 42 calls for identifying the selected fields 24 from the query for graphing. The second step 42 may include the dragging and dropping technique. A third step 43 calls for graphing the data from the selected fields 24.

The teachings herein are not meant to be limiting. The teachings discuss SQL driven graphs. The teachings also apply to other computer languages used to query databases. The teachings also discuss dragging and dropping. Other GUI 20 techniques may also be employed such as clicking.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A computer program product stored on machine readable media comprising machine readable instructions for providing a graphical user interface (GUI) for graphing results of a Structured Query Language (SQL) query, the instructions implementing a method comprising:
displaying fields identified by the query;
identifying selected fields from the query for graphing; and
graphing the data from the selected fields.

2. The computer program product as in claim 1, wherein the displaying comprises providing a listing of fields identified by the query.

3. The computer program product as in claim 1, wherein identifying selected fields comprises selecting fields from the displayed fields by using a pointing device.

4. The computer program product as in claim 1, wherein identifying selected fields comprises dragging and dropping the selected fields for the graphing.

5. The computer program product as in claim 1, wherein identifying selected fields comprises dragging and dropping the selected fields into a graphing parameter section.

6. The computer program product as in claim 5, further comprising dragging and dropping the selected fields from the graphing parameter sections.

7. The computer program product as in claim 1, further comprising instructions for providing an X-axis.

8. The computer program product as in claim 1, further comprising instructions for providing a secondary X-axis.

9. The computer program product as in claim 1, further comprising instructions for providing a primary Y-axis.

10. The computer program product as in claim 1, further comprising instructions for providing a secondary Y-axis.

11. The computer program product as in claim 1, further comprising instructions for providing a flyover window.

12. The computer program product as in claim 1, further comprising instructions for providing graphical enhancements.

13. The computer program product as in claim 1, wherein graphing the data comprises graphing the data in an order the selected fields are presented in the graphing parameter sections.

14. The computer program product as in claim 1, further comprising instructions for changing the order of the selected fields.

15. The computer program product as in claim 1, wherein the product is an add-in.

16. A computer system comprising a computer program product having instructions for providing a graphical user interface for graphing results of a Structured Query Language (SQL) query, the product comprising instructions for:
displaying fields identified by the query;
displaying a listing of the fields identified by the query;
identifying selected fields from the query for graphing;
selecting fields from the displayed fields by using a pointing device;
graphing the data from the selected fields;
dragging and dropping the selected fields for the graphing;
dragging and dropping the selected fields into a graphing parameter section;
dragging and dropping the selected fields from the graphing parameter sections;
providing an X-axis;
providing a secondary X-axis;
providing a primary Y-axis;
providing a secondary Y-axis;
providing a flyover window;
providing graphical enhancements;
graphing the data in an order the selected fields are presented in the graphing parameter sections; and
changing the order of the selected fields.
